(19) United States
(12) Patent Application Publication
(10) Pub. No.: US 2020/0059125 A1
(43) Pub. Date: Feb. 20, 2020

(54) ROTATING ELECTRIC MACHINE COMPRISING A STATOR WITH SEALED SLOTS, AND MORE PARTICULARLY PERMANENT MAGNET-ASSISTED RELUCTANT SYNCHRONOUS ELECTRIC MACHINE

(71) Applicants: IFP Energies nouvelles, Rueil-Malmaison Cedex (FR); MAVEL S.r.l., PONT SAINT MARTIN (IT)

(72) Inventors: Benjamin GAUSSENS, BUC (FR); Julien BOISSON, RUEIL MALMAISON (FR); Luca FAVRE, VALPELLINE (AO) (IT); Davide BETTONI, SETTIMO VITTONE TO ITALY (IT); Wissam DIB, SURESNES (FR)

(21) Appl. No.: 16/487,486

(22) PCT Filed: Feb. 16, 2018
(86) PCT No.: PCT/EP2018/053884

§ 371 Date: Aug. 21, 2019

(30) Foreign Application Priority Data
Feb. 24, 2017 (FR) 1751523

(51) Int. Cl. H02K 3/493; H02K 1/27; H02K 1/16; H02K 21/14

(52) U.S. Cl. CPC H02K 3/493; H02K 21/14; H02K 1/16; H02K 1/2766

(57) ABSTRACT

The present invention relates to an electric machine comprising a rotor (1) and a stator (2) having a wall (3) opposite the rotor, said stator comprising a multiplicity of radial slots arranged circumferentially along said stator. Said slots are provided with apertures (6) opening into said inner wall that are closed by closing means (7, 8) so as to form a multiplicity of closed slots (5).

### CROSS REFERENCE TO RELATED APPLICATIONS

Reference is made to PCT/EP2018/053884 filed Feb. 16, 2018, designating the United States, and French Application No. 17/51.523 filed Feb. 24, 2017, which are incorporated herein by reference in their entirety.

### BACKGROUND OF THE INVENTION

### Field of the Invention

The present invention relates to a rotary electrical machine with a closed-slot stator and more particularly to a permanent magnet-assisted synchro-reluctant electrical machine. More precisely, the electrical machine comprises a stator with open slots that are closed by suitable means so that the air gap between the outer surface of the rotor and the inner surface of the stator is substantially constant.

### Description of the Prior Art

Generally, such an electrical machine comprises a stator and a rotor arranged along the same axis in one another. The rotor includes a rotor body having a bundle of laminations arranged on a rotor shaft. These laminations include housings for permanent magnets, and perforations for creating flux barriers allowing the magnetic flux of the magnets to be radially directed towards the stator. The rotor is generally housed within a stator that carries electrical coils to generate a magnetic field allowing the rotor to be rotated.

As better described in document EP-1,057,242, the stator has an annular shape and it comprises radial slots that open in the direction of the rotor and extend all along the stator periphery.

These slots receive armature coils that are fed into the stator through the open face of the slots prior to being attached thereto by any known mechanism.

Substantial torque ripple is generally observed in this type of permanent magnet-assisted synchro-reluctant machine.

Torque ripple may generate jolts and vibrations at the rotor, thus causing discomfort in using the machine.

Document WO-2016/188,764 describes an electrical machine with a closed-slot stator which reduces the torque ripple and the acoustic noise. However, this solution notably requires an unconventional manufacturing process due to the closed slots.

### SUMMARY OF THE INVENTION

The present invention therefore relates to an electrical machine comprising a rotor and a stator having an inner wall opposite the rotor. The stator comprises radial slots arranged circumferentially along the stator with the slots being provided with apertures opening into the inner wall.

According to the invention, the apertures are closed by a closing structure or closing means to form closed slots.

The slots of the electrical machine can extend longitudinally along the axis of the stator.

The closing structure of closing means can comprise a wedge made of a magnetic material, whose dimensions correspond to the apertures to close the slots.

The thickness of the wedges can be such that they are flush with the surface of the inner wall of the stator.

The wedges can be crimped, welded or glued in the apertures.

The closing structure or closing means can comprise a cylinder made of a magnetic material, arranged on the inner wall of the stator to close the slots.

The cylinder can be fastened by press fitting the cylinder into the inner wall of the stator.

The inside diameter of the cylinder can be adapted to receive the rotor.

### BRIEF DESCRIPTION OF THE DRAWINGS

Other features and advantages of the invention will be clear from reading the description hereafter, given by way of non limitative example, with reference to the accompanying figures wherein:

FIGS. 1a and 1b are cross-sectional schematic views of electrical machines according to the prior art;

FIGS. 1c and 1d are cross-sectional schematic views of the stator of the machine according to the invention;

FIG. 2a is a graph illustrating the constant-current torque evolution as a function of the electrical position of the rotor for electrical machines of the prior art and for two electrical machines according to the invention; and

FIG. 2b is a graph giving the amplitude of the torque harmonics (N.m) for the four electrical machines described in FIGS. 1a, 1b, 1c and 1d.

### DETAILED DESCRIPTION OF THE INVENTION

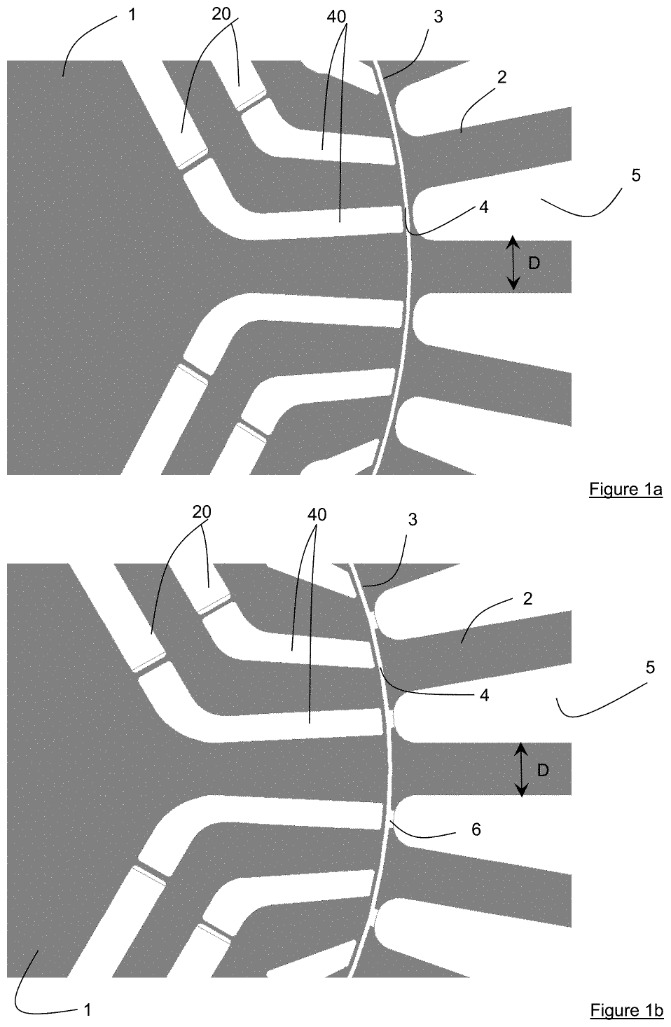

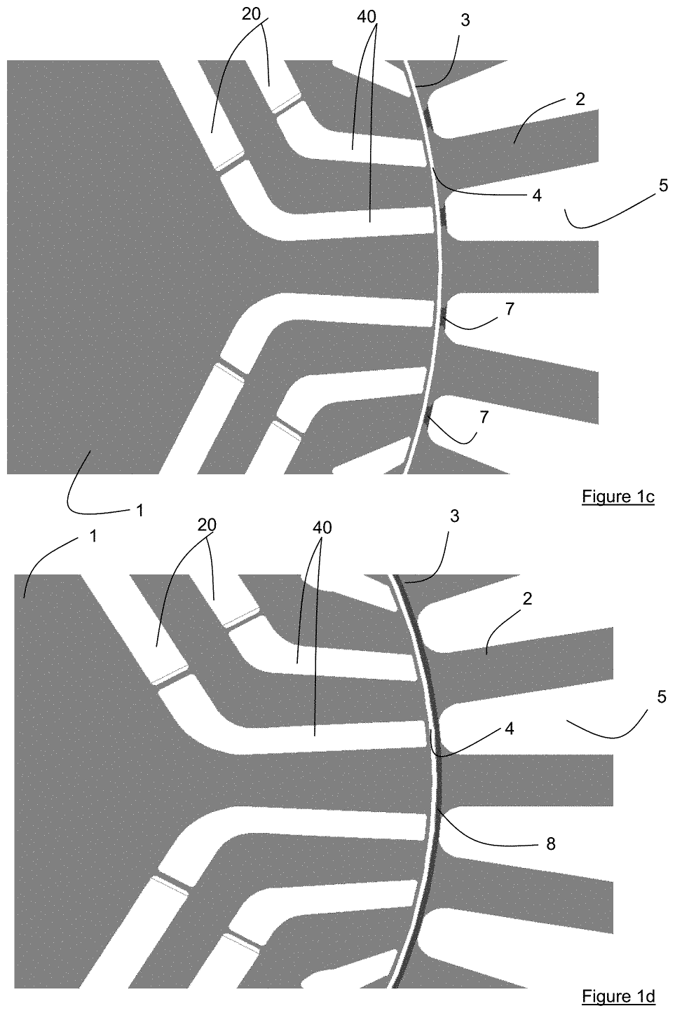

FIGS. 1a, 1b, 1c and 1d show in partial section a rotary electrical machine, which here is a permanent magnet-assisted synchro-reluctant electrical machine, comprising a rotor 1 and a stator 2 fitted into each other coaxially.

The rotor construction includes, as is well known and notably described in document WO-2016/188,764, preferably a magnetic shaft comprising bundles of identical plane ferromagnetic laminations assembled to one another by any known means. FIGS. 1a to 1d show at least partly this type of rotor.

The laminations of circular shape comprise a central bore traversed by the rotor shaft and a plurality of axial recesses 20 running throughout the laminations.

A series of rectangular axial recesses 20, radially arranged one above the other and spaced at a distance from one another, which form housings for magnetic flux generators, which here are permanent magnets in a form of rectangular bars of identical length substantially equal to the length of the lamination bundle. Preferably, the rotor comprises at least two series of rectangular axial recesses 20, radially arranged one above the other, with the rectangular axial recesses 20 being circumferentially distributed over rotor 1.

Another series of recesses 40 are perforations inclined in a radial direction that extend the housings through to the vicinity of the edge of the laminations.

Flux barriers formed by the perforations are thus created. The magnetic flux from the magnets then can only be transmitted through the solid portions between the perforations.

The presence of series of rectangular axial recesses 20 radially arranged one above the other and at a distance from one another, forming housings for magnetic flux generators, and the inclined radial perforations 40 extending the housings through to the vicinity of the laminations edge improves the direction of the magnetic flux and thus improves the electrical machine performance. The magnetic flux is then better channeled on walls of the rotor, which are both more numerous and thinner.

A stator 2 according to the prior art, as partly shown in FIGS. 1a, 1b, comprises an annular ring with an inner wall 3 having an inside diameter designed to receive rotor 1 with a space necessary to provide an air gap 4.

This ring comprises a multiplicity of holes 5, of oblong section here, forming slots designed to receive the armature coils.

More precisely, these holes extend axially all along the stator by being radially arranged on the ring while being circumferentially arranged at a distance from one another, by a distance D.

FIG. 1a describes a closed volume forming a closed slot intended to receive the armature coil.

Thus, wall 3 is a continuous wall and air gap 4 is quasi-constant between the rotor and the stator, over the entire circumference thereof.

Furthermore, as the outside of the rotor and the inside of the stator are smooth, a reduced aerodynamic noise is obtained.

Document WO-2016/188,764 notably describes the advantages of the closed slots.

FIG. 1b describes the conventional configuration of a stator with slots opening at the bottom thereof by apertures 6. These apertures allow winding of the armatures, in particular mechanical winding, whereas in the case of closed slots the armature coils need to be achieved manually.

The object of the present invention is both to combine the benefit provided by closed slots with an open-slot stator allowing to reduce the cost of making with the possibility of automated winding and to obtain a better winding coefficient, of the order of 0.6.

Therefore, after winding, apertures 6 of the stator are closed by a suitable means or mechanism such as plates or wedges made of a magnetic material of the same width as apertures 6 and of length corresponding to the length of the stator. FIG. 1c illustrates this embodiment with a sectional view of the closing means or closing structure 7 in form of a wedge or a plate. These closing means or closing structure can be crimped, glued, welded or secured by any means available to the person skilled in the art.

The thickness of these wedges is advantageously such that they are flush with the surface of the inner wall of the stator.

Thus, the air gap is substantially constant over the entire circumference, and inner surface 3 of the stator is practically smooth.

FIG. 1d describes another embodiment of the closing means or closing structure closing the open slots 5. A cylinder 8, whose diameter and length correspond to the inner surface and to the length of the stator respectively, is arranged on inner surface 3 of the open stator.

Thus, the inner surface of the stator is entirely covered by the wall of cylinder 8, or retaining ring, and all the apertures of the slots are thus closed. Air gap 4 is made up of the outer surface of the rotor and the inner surface of ring 8. Cylinder 8, which is referred to as a retaining ring, is made of a magnetic material. The cylinder can be fastened onto inner surface 3 of the stator by any means or mechanism known to the person skilled in the art, notably by press fitting, gluing, welding. Cylinder 8 is thin in thickness in relation to the diameter thereof. Therefore press fitting is a suitable process of retention. Hence the denomination of “retaining ring” for the means of closing the apertures of the stator slots.

In a permanent magnet-assisted synchro-reluctant structure, closing the open slots of a stator affords three advantages:
reduction of torque ripple (and of the torque ripple harmonics),
reduction of rotor and stator iron losses (less harmonics on the magnetic induction in iron),
reduction of the noise caused by aerodynamic phenomena of the machine since the air gap is constant.

When rotor 1 of the permanent magnet-assisted synchro-reluctant machine comprises series of rectangular axial recesses 20 radially arranged one above the other, at a distance from one another, and forming housings for magnetic flux generators, and when the rotor also comprises recesses 40 of inclined radial perforation type, extending the housings through to the vicinity of the laminations edge (as illustrated in FIGS. 1a to 1d), in combination with the use of closing means or closing structure (7, 8) for the stator slots, the synchro-reluctant machine has significantly improved performances.

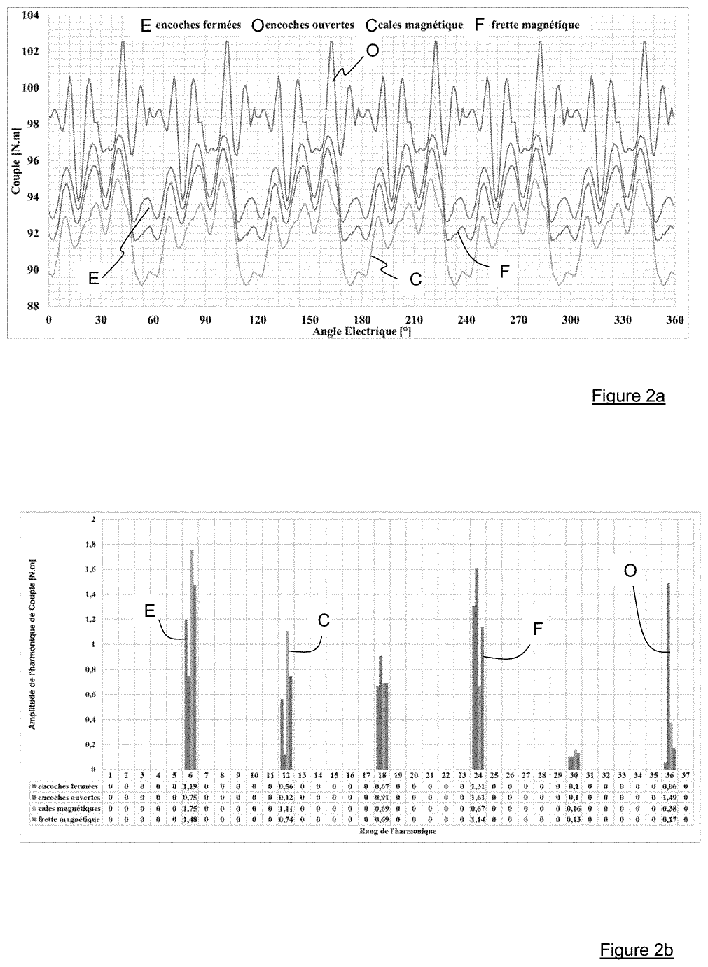

FIG. 2a is a graph with curves illustrating the torque of the electrical machine (in N.m) in relation to the electrical position of the rotor (in °) for a constant current, for the four embodiments of the stator: closed slots E, open slots O, slots closed by wedges C, slots closed by retaining rings F.

It can be noted that, in the case of open slots O, the torque ripple is much higher (9.0%), whereas it is 5.1%, 6.4%, 5.4% respectively for the configurations with closed slots E, slots closed by magnetic wedges C and slots closed by magnetic rings F.

Furthermore, FIG. 2b shows the level of the harmonic content of the instant torque. It is noted that, in the case of the stator with open slots, rank 36 corresponding to the number of teeth of the stator prevails. In the other configurations, the amplitude of the harmonics tends to decrease while the frequency thereof increases. This is interesting, notably regarding iron losses, because high order harmonics that might generate greater losses (iron losses being proportional to, f, f² and f^{3/2}) are not excited.

It is clear that a posteriori closing of the slots receiving the armature coils, notably with magnetic wedges or magnetic retaining rings, reduces the torque ripple more when compared with the open-slot stator structure, as well as the torque harmonics.

Besides, a posteriori closing causes no significant changes in the electromagnetic performances compared with the closed-slot structure.

1.-8. (canceled)

9. An electrical machine comprising a rotor and a stator having an inner wall opposite the rotor, the stator comprising radial slots arranged circumferentially along the stator, the slots having open apertures opening into the inner wall, and wherein the apertures are closed by closing means which close the opening to form closed slots.

10. An electrical machine as claimed in claim 9, wherein the slots extend longitudinally along an axis of the stator.

11. An electrical machine as claimed in claim 9, wherein the closing means comprises a wedge made of a magnetic material, having dimensions corresponding to the open apertures to close the slots.

12. An electrical machine as claimed in claim 10, wherein the closing means comprises a wedge made of a magnetic material, having dimensions corresponding to the open apertures to close the slots.

13. An electrical machine as claimed in claim 11, wherein a thickness of the wedges is flush with a surface of the inner wall of the stator.

14. An electrical machine as claimed in claim 12, wherein a thickness of the wedges is flush with a surface of the inner wall of the stator.

15. An electrical machine as claimed in claim 11, wherein the wedges are crimped, welded or glued in the apertures.

16. An electrical machine as claimed in claim 12, wherein the wedges are crimped, welded or glued in the apertures.

17. An electrical machine as claimed in claim 13, wherein the wedges are crimped, welded or glued in the apertures.

18. An electrical machine as claimed in claim 14, wherein the wedges are crimped, welded or glued in the apertures.

19. An electrical machine as claimed in claim 9, wherein the closing means comprises a cylinder made of a magnetic material, located on the inner wall of the stator, to close the open slots.

20. An electrical machine as claimed in claim 10, wherein the closing means comprises a cylinder made of a magnetic material, located on the inner wall of the stator, to close the open slots.

21. An electrical machine as claimed in claim 19, wherein the cylinder is press fit to the inner wall of the stator.

22. An electrical machine as claimed in claim 20, wherein the cylinder is press fit to the inner wall of the stator.

23. An electrical machine as claimed in claim 19, wherein an inside diameter of the cylinder receives the rotor.

24. An electrical machine as claimed in claim 20, wherein an inside diameter of the cylinder receives the rotor.

25. An electrical machine as claimed in claim 21, wherein an inside diameter of the cylinder receives the rotor.

26. An electrical machine as claimed in claim 22, wherein an inside diameter of the cylinder receives the rotor.
